(19) United States
(12) Patent Application Publication
(10) Pub. No.: US 2003/0012151 A1
(43) Pub. Date: Jan. 16, 2003

(54) System and method for paging for voice over IP

(76) Inventor: Dan Vassilovski, Del Mar, CA (US)

Correspondence Address: Sarah Kirkpatrick, Intellectual Property Administration, QUALCOMM Incorporated, 5775 Morehouse Drive, San Diego, CA, 92121-1714, US

(21) Appl. No.: 09/905,007

(22) Filed: Jul. 12, 2001

(51) Int. Cl. H04B 7/216; H04L 12/66

(52) U.S. Cl. 370/312; 370/342; 370/352; 340/7.29

(57) ABSTRACT

A wireless telephone without IP capability nonetheless communicates with an infrastructure that uses IP. An infrastructure component assigns the wireless telephone a temporary IP address based on the location of the telephone, and then transforms over-the-air (OTA) voice protocol packets, such as IS-95 CDMA packets, from the wireless telephone to IP packets. The IP packets are sent through the infrastructure to another communication device. In turn, IP packets representing voice communication from the communication device are sent through the infrastructure, transformed to OTA packets, and transmitted to the wireless telephone.

### BACKGROUND OF THE INVENTION

I. Field of the Invention

The present invention relates generally to enabling a wireless telephone that is not required or generally configured to support voice over Internet Protocols (VOIP) to nonetheless communicate with wireless telephone infrastructure that uses IP structures or architectures, with IP-based communication between the wireless telephone infrastructure and any VOIP-based infrastructure being supported.

II. Background of the Invention

Wireless telephones, such as but not limited to wireless telephones that communicate using Code Division Multiple Access (CDMA) spread spectrum modulation techniques, communicate over the air with system infrastructure using wireless telephone over-the-air communication protocols, e.g., the CDMA protocols known as IS-95A, IS-95B, and IS-2000. The system infrastructure, which can include base stations (BTS), base station controllers (BSC), and other components, connects the wireless telephone to another communication device, such as a through land line or another wireless communication system.

In the case of CDMA, voice data is sent over the air in packets that are collected by the infrastructure and assembled into a voice stream, transparently to the speakers who are talking to each other. As might be expected, the over-the-air protocol is tailored to optimize wireless communication. For instance, to maximize over-the-air capacity, the over-the-air protocol contains a minimum of signalling information, and the size of a voice data packet is relatively small.

With the growth of the Internet, computer-to-computer communication using Internet Protocols (IP) has become ubiquitous. Furthermore, it has become desirable not only to facilitate computer data communication using IP, but to facilitate voice communication using IP as well. As but one advantage afforded by using IP in a telephony infrastructure, much hardware such as switches can be eliminated, and existing computers and software can be used instead, reducing cost. To this end, so-called voice over IP (VOIP) has been introduced.

To support VOIP, a communication device must have, among other requirements, IP capability, i.e., the device must itself be able to communicate using IP, and it must have an IP address.

The present invention critically observes, however, that requiring a wireless telephone to use VOIP diminishes over-the-air capacity because VOIP is not necessarily designed to maximize such capacity. Instead, VOIP accounts for design considerations that are not necessarily related to wireless telephony. As an example, the data packet size of VOIP is relatively large, compared to the packet size used throughout the wireless communication industry such as in wireless telephones using over-the-air protocols such as IS-95. Indeed, a typical packet size in the IS-95 protocol is less than the size of a single packet header employed in a typical IP. Moreover, configuring a wireless telephone to communicate using both IP and over-the-air protocols complicates telephone design, adversely strains available resources (e.g., power, computing cycles, coding, and so on), and increases costs.

Nonetheless, the present invention understands that it would be desirable to enable wireless telephone communication using an infrastructure that transmits data in accordance with IP principles. With the above considerations in mind, the present invention provides the solutions disclosed below.

### SUMMARY OF THE INVENTION

A method for paging a wireless telephone using an over-the-air (OTA) protocol in an infrastructure communicating within the infrastructure in Internet Protocol (IP) includes associating the telephone with a temporary IP address based at least in part on a location of the telephone. The method also includes paging the telephone by sending a page message to the temporary IP address. By “page message” is meant a request for communication to a mobile communication device.

In a preferred embodiment, the temporary IP address is allocated to a base station in the infrastructure. The base station establishes a virtual IP endpoint, and the page message is received at the base station. The virtual IP endpoint undertakes a table lookup to correlate the temporary IP address with the telephone. In one embodiment, the temporary IP address is a multicast address allocated to more than one virtual IP endpoint, such that the page message is transmitted to the multicast IP address and each IP endpoint receives the page message for transmission thereof to the telephone. A single IP multicast address can be associated with plural wireless telephones to simplify tracking requirements.

A “multicast” address can be, e.g., an SIP multicast address, or an IP multicast address, or an H.323 multicast address. Moreover, a “multicast” address can be a collective group or series of individual base station addresses, with a wireless device configured to respond to any one of the addresses in the group or series.

For instance, a pool of IP addresses can be reserved solely for paging. In such a system, each base station reserves an IP address for assignment to idle wireless devices for the purpose of paging. As an example, in an IP address of the form X.X.X.X, where X represents a respective byte, IP addresses having “01” in the third byte might be reserved for paging. In this example, if a base station registers a wireless device with the X.X.01.X address, the below-described SIP server would know that any incoming call for that device would require a message sent to all base stations using the X.X.01.X address. In this way, by issuing multiple unicast messages, a multicast page essentially is achieved.

In another aspect, a telephone system includes at least one wireless endpoint such as but not limited to a mobile telephone and an infrastructure supporting IP. The infrastructure includes a virtual IP endpoint such as but not limited to a base station that communicates with the wireless endpoint. The virtual IP endpoint receives a page message having an IP address allocated to the virtual IP endpoint and intended for receipt by the wireless endpoint. According to this aspect, the virtual IP endpoint provides the page message to the wireless endpoint.

In still another aspect, a computer program product includes logic means for allocating at least one IP address to at least one virtual IP endpoint in an IP-based telephony infrastructure. Logic means are provided for associating at least a first wireless telephone with the IP address based at least in part on a geographic location of the telephone. With this invention, the telephone can be paged by sending a page message through the infrastructure addressed to the IP address.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a presently preferred inventive wireless communication system;

FIG. 2 is a flow chart of the logic for communicating with a non-IP-based wireless device using an IP-enabled infrastructure when the wireless device establishes and maintains the call;

FIG. 3 is a flow chart of the logic for communicating with a non-IP wireless telephone using an IP-enabled infrastructure when the wireless telephone is called;

FIG. 4 is a flow chart of a first method for assigning an IP address to a wireless telephone; and

FIG. 5 is a flow chart of a second method for assigning an IP address to a wireless telephone.

### DETAILED DESCRIPTION OF THE PREFERRED EMBODIMENT

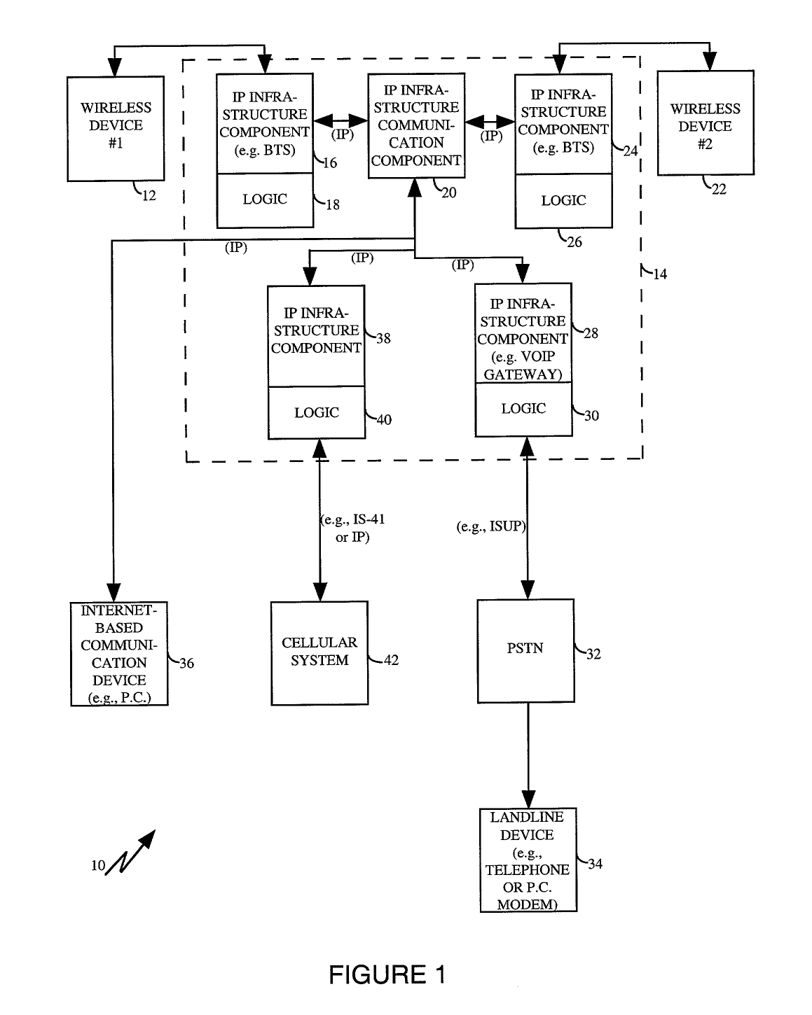

Referring initially to FIG. 1, a system is shown, generally designated 10, for effecting communication between a target wireless communication device 12 that does not support voice over Internet Protocols (VOIP) and a telephony infrastructure 14 that supports IP. By “does not support VOIP” or “does not support IP” is meant that the device 12 either has no IP or VOEP capability, or that it has such capability but for improved performance uses a standard over the air (OTA) protocol such as a spread spectrum scheme like CDMA or WCDMA or other wireless protocol such as but not limited to TDMA, UMFS, TD-SCDMA, etc. to communicate with the infrastructure 14. In one non-limiting embodiment the device 12 is a mobile telephone made by Kyocera, Samsung, or other manufacturer that uses Code Division Multiple Access (CDMA) principles and CDMA over-the-air (OTA) communication air interface and includes protocols such as defined in but not limited IS-95A, IS-95B, UCDMA, IS-2000, and others to communicate with the infrastructure 14.

For instance, the wireless communication systems to which the present invention can apply, in amplification to those noted above, include Personal Communications Service (PCS) and cellular systems, such as Analog Advanced Mobile Phone System (AMPS) and the following digital systems: CDMA, Time Division Multiple Access (TDMA), and hybrid systems that use both TDMA and CDMA technologies. A CDMA cellular system is described in the Telecommunications Industry Association/Electronic Industries Association (TIA/EIA) Standard IS-95. Combined AMPS and CDMA systems are described in TIA/EIA Standard IS-98. Other communications systems are described in the International Mobile Telecommunications System 2000/Universal Mobile Telecommunications Systems (IMT-2000/UM), standards covering what are referred to as wideband CDMA (WCDMA), cdma2000 (such as cdma2000 1×or 3×standards, for example) or TD-SCDMA.

The present invention applies to any wireless communication device 12; for illustration it will be assumed that the device 12 is a telephone 12. In general, wireless communication devices to which the present invention applies may include but are not limited to a wireless handset or telephone, a cellular phone, a data transceiver, or a paging and position determination receiver, and can be hand-held, or portable as in vehicle-mounted (including cars, trucks, boats, planes, trains), as desired. However, while wireless communication devices are generally viewed as being mobile, it is to be understood that the present invention can be applied to “fixed” units in some implementations. Also, the present invention applies to data modules or modems used to transfer voice and/or data information including digitized video information, and may communicate with other devices using wired or wireless links. Further, commands might be used to cause modems or modules to work in a predetermined coordinated or associated manner to transfer information over multiple communication channels. Wireless communication devices are also sometimes referred to as user terminals, mobile stations, mobile units, subscriber units, mobile radios or radiotelephones, wireless units, or simply as “users” and “mobiles” in some communication systems.

As shown in FIG. 1, the wireless telephone 12 communicates, using one or more of the above-mentioned systems, with at least one first infrastructure component 16 that accesses a logic module 18 to execute the logic of the present invention. The first component 16 preferably is a base station (BTS), but it can also be implemented by base station controller (BSC), mobile switching center (MSC), gateway to a satellite system, or other infrastructure component. In any case, the first component 16 not only supports the necessary protocols and systems to communicate with the wireless device 12, but also supports IP and attendant protocols or stack of IP protocols, and accordingly communicates with a coordinating infrastructure component 20 such as a BSC or another BTS using IP. In turn, when the target wireless telephone 12 is to communicate with a second wireless telephone 22 in the same infrastructure 14 system, the coordinating component 20 communicates via IP with a second infrastructure component 24 such as a second BTS, which in turn executes a logic module 26 to communicate, using OTA protocol, with the second wireless telephone 22.

The infrastructure components 16, 24 thus communicate with their respective wireless telephones 12, 22 using OTA protocol but communicate internally to the infrastructure 14 using IP, thereby relieving the wireless telephones 12, 22 from having to support IP and attendant suite of voice over Internet protocols or from having to support any processing, use of resources, etc. related to implementing IP. Also, by using IP internally to the infrastructure 14 and OTA protocol between the telephones 12, 22 and the respective components 16, 24, the advantages of using IP internal to the infrastructure 14 are realized, whereas the advantages of OTA protocol in wireless communication to the telephones 12, 22 are preserved to maximize the over-the-air capacity of the system 10. Accordingly, the infrastructure components 16, 24 can be thought of as virtual IP endpoints, with the actual communication endpoints being the telephones 12, 22.

FIG. 1 further shows that the target wireless telephone 12 can also communicate with communication devices outside of the infrastructure 14. Specifically, the infrastructure 14 can include a VOIP gateway 28 with logic module 30 for communicating, in accordance with principles known in the art, with the coordinating infrastructure component 20 and with a public switch telephone network (PSTN) 32. The communication between the coordinating component 20 and the VOIP gateway 28 can be via IP, whereas the communication between the VOIP gateway 28 and the PSTN 32 can be via a signalling protocol such as ISUP using a physical system such as the system known as SS7. In turn, the PSTN includes one or more landline devices 34 such as telephones or modems, to complete the communication pathway between the target wireless telephone 12 and the landline devices 34.

Additionally, the target wireless telephone 12 can communicate with an Internet-based communication device 36 such as a personal computer (PC), data server, intranet portal, or other computer. The Internet-based device 36 communicates with the coordinating infrastructure component 20 using IP.

Still further, the infrastructure 14 can include an interface component 38 with logic module 40 for communicating with the coordinating component 20 within the infrastructure 14 and with wireless communication systems 42 that are outside of the infrastructure 14. For example, the interface component 38 can be a mobile switching center (MSC) or gateway. Communication between the interface component 38 and coordinating component 20 can use IP, whereas communication between the interface component 38 and the other wireless/cellular systems 42 can use IS-41 protocol or IP.

With the above overview of the present architecture in mind, it is to be understood that the present logic is executed on the architecture shown in FIG. 1 in accordance with the flow charts discussed below. The flow charts herein illustrate the structure of the logic of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer, controller, processor, etc.) to perform a sequence of function steps corresponding to those shown.

In other words, the logic may be embodied by a computer program that is executed by a processor within, e.g., the infrastructure component 16 as a series of computer- or control element-executable instructions. These instructions may reside, for example, in RAM or on a hard drive or optical drive, or the instructions may be stored on magnetic tape, electronic read-only memory, or other appropriate data storage device that can be dynamically changed or updated.

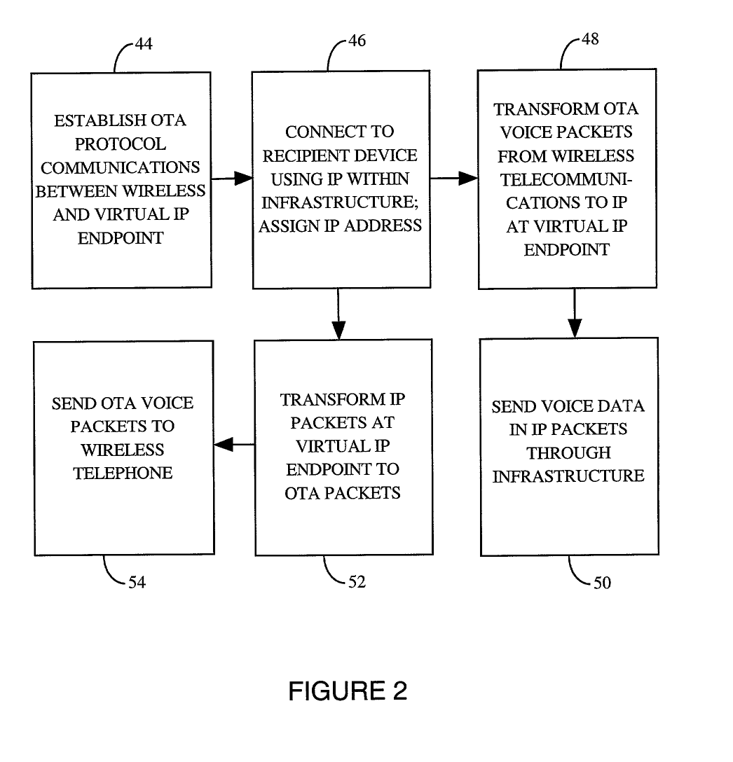

Now referring to FIG. 2, the logic that is executed when the target wireless telephone 12 places a call is shown. Commencing at step 44, communication using an appropriate over-the-air (OTA) protocol is established between the telephone 12 and the first component 16, i.e., between the telephone 12 and the virtual IP endpoint of the present invention. In one exemplary, non-limiting embodiment, the process at step 44 can include receiving a CDMA protocol origination message from the telephone 12 in, for example, IS-95 protocol, and then in response essentially transforming the origination message to IP by sending an IP-based Session Initiation Protocol (SIP) messages from the first component 16 to other appropriate server components within the infrastructure 14 in accordance with principles known in the art. These SIP messages can ascertain the location of the telephone 12 and establish communications with the intended recipient's endpoint. In the case wherein the recipient is the second wireless telephone 22, IP communication is established between the virtual endpoints which are established by the components 16, 24.

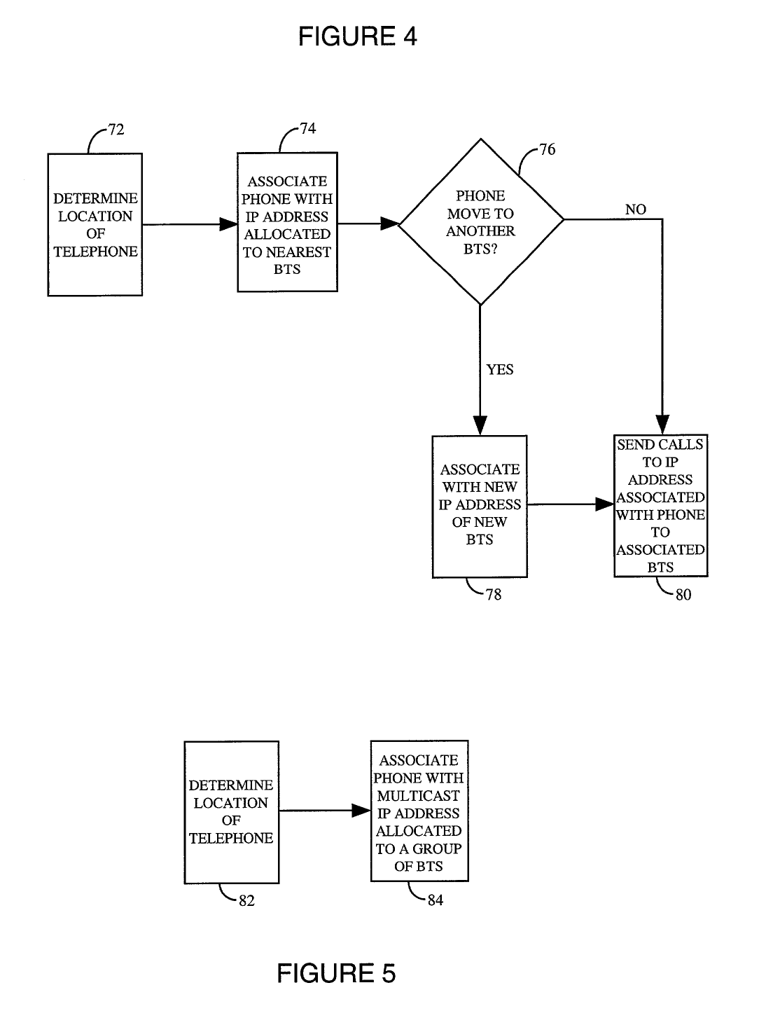

Proceeding to step 46, the infrastructure 14 connects to the recipient device using the above-disclosed IP messaging in the infrastructure 14. In the case of the second wireless telephone 22 being the recipient, the second component 24 establishes communication with the telephone 22 using OTA protocol messages. In contrast, when the recipient is the Internet-based communication device 36, IP communication is established in accordance with principles known in the art between the device 36 and the infrastructure 14. On the other hand, when the recipient is the cellular system 42, communication is established between the infrastructure 14 and the system 42 using IP or other protocol known in the art, e.g., IS-41. Still further, when the landline 34 is contacted, communication is established between the infrastructure 14 and the PSTN 32 using a protocol known in the art, such as ISUP. Also, as indicated in FIG. 2 an IP address is assigned to the telephone 12. The details of how IP addresses are assigned are discussed further below in reference to FIGS. 4 and 5.

Once communication is established, the processing can perform parallel tasks steps 48 and 52. At step 48, OTA packets such as OTA voice packets from the wireless telephone 12 are transformed or otherwise converted to IP at the virtual IP endpoint, i.e., the first component 16. To make this transformation, the contents of the OTA voice packets are rearranged as appropriate to conform to IP packet requirements. Typically, since OTA voice packets are smaller than IP packets and frequently are smaller than the headers of IP packets, several OTA packets might be combined into a single IP packet, although this might not necessarily be the case particularly for latency intensive applications. The information in IP, which can represent voice, digital data, digitized image data, or other type of data is sent through the infrastructure 14 toward the recipient at step 52.

Likewise, at step 52 IP packets representing information that originated at the recipient device move through the infrastructure 14 and are converted to OTA packets by the first component 16, i.e., by the virtual IP endpoint. The OTA packets are sent to the telephone 12 at step 54. The transformation from IP to OTA protocol is the reverse of the process for converting OTA packets to IP packets, i.e., each IP packet might be separated into a set of smaller OTA packets as appropriate to conform to the OTA protocol used by the telephone 12.

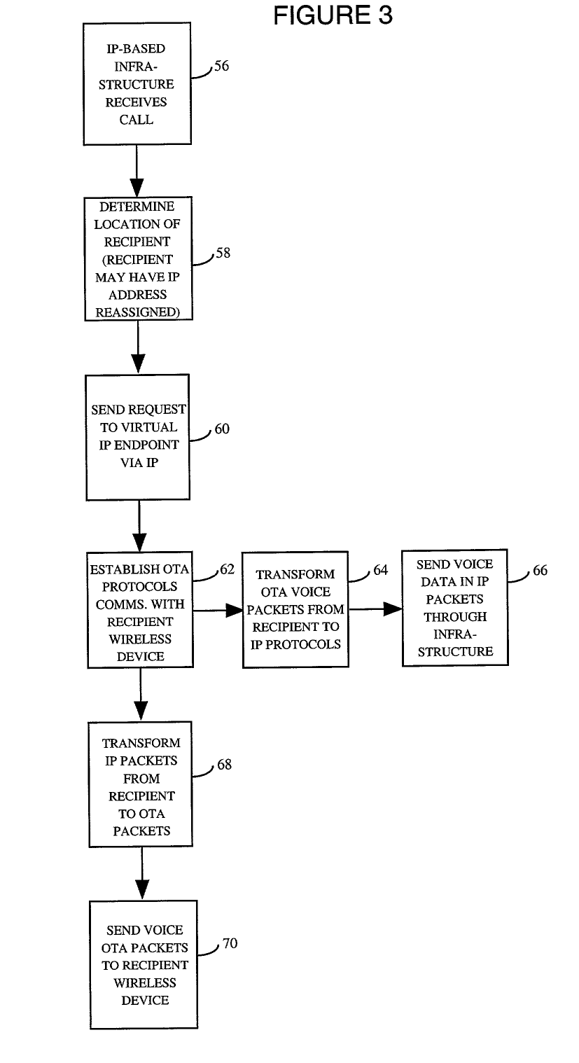

FIG. 3 shows the logic that is invoked when the telephone 12 is contacted.

Commencing at step 56, the infrastructure receives a call request for the telephone 12. At step 58, the location of the telephone 12 is determined in accordance with locating principles known in the art, e.g., global positioning satellite or known network techniques. Typically, the location is established by the telephone 12 being detected by one or more base stations, with the closest detecting base station location being known. The call request is sent to the virtual IP endpoint (i.e., the first component 16) via IP at step 60.

Moving to step 62, OTA protocol communications are established with the telephone 12. Then, OTA protocol packets from the telephone 12 are transformed to IP and sent through the infrastructure 14 at steps 64 and 66 in accordance with principles discussed above. Also, IP packets representing information intended for the telephone 12 are converted to OTA protocol packets and sent over the air to the telephone 12 at steps 68 and 70 in accordance with principles discussed above.

FIG. 4 shows one method for paging the telephone 12 by assigning a temporary IP address to the telephone 12. By “paging” generally is meant “contacting” or “periodically establishing a connection”. Commencing at step 72, the location of the telephone is determined in accordance with principles known in the art. Moving to step 74, an IP address that has been allocated to the receiving virtual IP endpoint (e.g., to the BTS closest to the telephone 12) is associated with the telephone 12. This address is recorded in the infrastructure 14 in, e.g., table lookup form, as being the address of the telephone 12. By “IP address” is meant an address useful in identifying intended recipients of IP packets. This can include a conventional IP address numeric string and/or an alpha-numeric address associated with the string. In one non-limiting example, the alpha-numeric address can be the telephone number of the telephone 12 with an IP identifier appended thereto, e.g., 5551212@qualcomm.com. More generally, the IP address can include a wireless device identification such as an electronic serial number.

Next, if it is determined at step 76 that the telephone 12 has moved into the area of another BTS, the process proceeds to step 78 to associate an IP address allocated to the new BTS with the telephone 12. In any case, when a call is received for the telephone 12 the process proceeds to step 80 to page the telephone 12. A page message may include the contents conventionally delivered to BTS by MSC when paging a cellular device using existing cellular infrastructure protocols. These contents may include the destination wireless telephone 12 identifier and details regarding the desired communication. The BTS may subsequently transmit OTA page messages to the telephone 12.

Once the telephone 12 answers the page, communication is established as set forth above, using the temporary IP address of the telephone 12 to route IP information through the infrastructure 14. That is, information intended for the telephone 12 is associated with the IP address of the telephone 12, and then sent to the virtual IP endpoint for conversion thereof to OTA protocol and transmission to the telephone 12.

While the logic of FIG. 4 provides for highly efficient paging process, FIG. 5 shows a method for minimizing the assignment of temporary IP addresses to wireless telephones in the system 10 and, hence, to minimize the number of messages that must be used for assigning IP addressed to wireless telephones. Commencing at step 82, the location of the wireless telephone 12 is determined. Proceeding to step 84, the telephone 12 is associated with an IP address that is a multicast address allocated to more than one virtual IP endpoint, e.g., that is an address allocated to a group of BTS or other such component, or that is a collection of individual BTS addresses. In this embodiment, the page message is transmitted to the multicast address associated with the telephone 12, i.e., is transmitted to each BTS in the multicast group. The virtual IP endpoints in the multicast group then transmit OTA pages to the wireless telephone 12, and communication is established between the infrastructure 14 and the wireless telephone 12.

Because the contents of the page message sent to the multicast address specifies the target wireless telephone 12, a single IP multicast address can be associated with multiple wireless telephones, thereby simplifying tracking requirements on the system 10. As mentioned above, a “multicast address” can be a group of individual base station addresses if desired. After paging is successful, the telephone 12 is assigned a second, unique IP address to which data packets are routed. The EP address is assigned from the BTS handling the call.

While the particular SYSTEM AND METHOD FOR PAGING FOR VOICE OVER IP as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act.”

What is claimed is:

1. A method for paging a wireless communication device using an over-the-air (OTA) protocol in an infrastructure communicating within the infrastructure in Internet Protocol (IP), comprising:
associating the communication device with a temporary IP address based at least in part on a location of the communication device; and
paging the communication device by sending a page message to the temporary IP address.

2. The method of claim 1, wherein the temporary IP address is allocated to a base station in the infrastructure.

3. The method of claim 2, wherein the base station establishes a virtual IP endpoint, and the page message is received at the base station.

4. The method of claim 3, wherein the virtual IP endpoint undertakes a table lookup to correlate the temporary IP address with the communication device.

5. The method of claim 3, wherein the temporary IP address is a multicast address allocated to more than one virtual IP endpoint.

6. The method of claim 5, wherein the page message is transmitted to the multicast address such that each IP endpoint receives the page message for transmission thereof to the communication device.

7. The method of claim 6, wherein a single multicast address is associated with plural wireless communication devices.

8. The method of claim 1, wherein the OTA protocol is a code division multiple access (CDMA) protocol.

9. A communication system, comprising:
at least one wireless endpoint in the system;
an infrastructure supporting IP, the infrastructure including a virtual IP endpoint communicating with the wireless endpoint, the virtual IP endpoint receiving a page message having an IP address allocated to the virtual IP endpoint and intended for receipt by the wireless endpoint, the virtual IP endpoint providing the page message to the wireless endpoint.

10. The system of claim 9, wherein the infrastructure allocates an IP address to the virtual IP endpoint and correlates the IP address to the wireless endpoint, such that the page message can be addressed to the virtual IP endpoint and transmitted to the wireless endpoint.

11. The system of claim 9, wherein the virtual IP endpoint undertakes a table lookup to correlate the IP address with the wireless endpoint.

12. The system of claim 9, wherein the IP address is a multicast address allocated to more than one virtual IP endpoint.

13. The system of claim 12, wherein the page message is transmitted to the multicast address such that each IP endpoint receives the page message for transmission thereof to the wireless endpoint.

14. The system of claim 13, wherein a single multicast address is associated with plural wireless endpoints to simplify tracking requirements.

15. A computer program product, comprising:
means for allocating at least one IP address to at least one virtual IP endpoint in an IP-based telephony infrastructure; and
means for associating at least a first wireless communication device with the IP address based at least in part on a geographic location of the communication device, whereby the communication device can be paged by sending a page message through the infrastructure addressed to the IP address.

16. The product of claim 15, further comprising at least one table accessible to the IP endpoint and useful for ascertaining a recipient of a telephone page message on the basis of the IP address.

17. The product of claim 15, wherein the means for allocating allocates the IP address to one and only one IP endpoint.

18. The product of claim 15, wherein the means for allocating allocates the IP address to more than one IP endpoint.
